(19) United States
(12) Patent Application Publication
(10) Pub. No.: US 2006/0143701 A1
(43) Pub. Date: Jun. 29, 2006

(54) Techniques for authenticating network protocol control messages while changing authentication secrets

(75) Inventors: Maria Alice Dos Santos, Hayward, CA (US); Prasad Yadati, Cupertino, CA (US); William Mark Townsley, Nashville, TN (US)

Correspondence Address: EVANS & MOLINELLI, PLLC, U.S. POST OFFICE BOX 7024, FAIRFAX STATION, VA, 22039, US

(73) Assignee: Cisco Technology, Inc.

(21) Appl. No.: 11/022,125

(22) Filed: Dec. 23, 2004

(51) Int. Cl. G06F 15/16

(52) U.S. Cl. 726/14

(57) ABSTRACT

A method and apparatus for changing a secret value used to authenticate network protocol control messages among network nodes in a trusted domain includes configuring each network node in the domain to use a first secret value to authenticate network protocol control messages among network nodes in the domain. After every network node in the domain has been configured with the first secret value, each network node in the domain is configured to use a different second secret value to authenticate network protocol control messages. After every network node has been configured with the second secret value, each network rode in the domain is configured to no longer use the first secret value to authenticate network protocol control messages. Thus a configured secret value for authentication is changed from the first secret value to the second secret value while maintaining communication of network protocol control messages within the domain.

### BACKGROUND OF THE INVENTION

1. Field of the Invention

The present invention relates to authenticating messages passed over a network using a shared secret, and, in particular, to a method and apparatus for changing one or more authentication secrets shared in a trusted domain while continuing to authenticate protocol control messages in that domain.

2. Description of the Related Art

Networks of general purpose computer systems connected by external communication links are well known. The networks often include one or more network devices that facilitate the passage of information between the computer systems. A network node is a network device or computer system connected by the communication links.

Information is exchanged between network nodes according to one or more of many well known, new or still developing protocols. In this context, a protocol consists of a set of rules defining how the nodes interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model. The OSI Reference Model is generally described in more detail in Section 1.1 of the reference book entitled Interconnections Second Edition, by Radia Perlman, published September 1999, which is hereby incorporated by reference as though fully set forth herein.

Communications between nodes are typically effected by exchanging discrete packets of data. Each packet typically comprises 1] header information associated with a particular protocol, and 2] payload information that follows the header information and contains information that may be processed independently of that particular protocol. In some protocols, the packet includes 3] trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, as defined by the Open Systems Interconnection (OSI) Reference Model.

Some protocols span the layers of the OSI Reference Model. For example, the Ethernet local area network (LAN) protocol includes both layer 1 and layer 2 information. The International Electrical and Electronics Engineers (IEEE) 802.3 protocol, an implementation of the Ethernet protocol, includes layer 1 information and some layer 2 information.

New protocols are developed to meet perceived needs of the networking community. One protocol is the layer 2 tunneling protocol (L2TP), which is used to establish and maintain a persistent path (often called a “virtual circuit”) between two non-adjacent nodes in a network. Some protocols, including L2TP, pass protocol-related information among two or more network nodes in special control packets that are communicated separately and which include a payload of information used by the protocol itself rather than a payload of data to be communicated for another application. These control packets and the processes at network nodes that utilize the control packets are said to be in another dimension, a “control plane,” distinct from the “data plane” dimension that includes the data packets with payloads for other applications. For example, routing information used by routers to direct data packets according to their IP addresses is passed between routers in a router control plane.

To ensure that these control messages are reliable and are not generated by a hostile or malicious user, the control messages are authenticated. The authentication process determines that the sender is who the sender claims to be and that the data received is the same as the data sent. That is, the process authenticates the user and verifies the integrity of the protocol control message. For example, when control messages are passed among a domain of network nodes within which secrets are kept (a “trusted domain”), a shared secret is used along with some cryptographic method for using that shared secret. In L2TP, for example, a secret large value and a portion of the transmitted message are input to a one-way hash function to form a message digest (also called a “message signature,” or a “digital signature”). The hash function is one-way if it is impractical to deduce the secret from the message and the digital signature in a reasonable time. The portion of the transmitted message input to the one-way hash function is an agreed upon portion of the message, such as, but not limited to, the control message header, the body of the control message, or some combination.

In some networks, the shared secret is provided to certain network nodes called peers. The shared secret is directed to peers individually as directed by one or more network administrators using manual input during a configuration step, with or without the assistance of a network element management system (EMS). The manual aspect of such a configuration step is favored by many network administrators because they are personally responsible for the performance of one or more network nodes and peers and each administrator wants to be sure that no one else has access to the configuration of these network nodes and peers.

Periodically, or when a shared secret is known or suspected to be compromised, such as when a network administrative employee terminates employment, the shared secret is changed. The secret transition time is the time it takes to change the secret value at every network peer in the trusted domain, which is to share the new secret. It is desirable that the secret transition time is short compared to the time between protocol control messages, or the time that a connection can be maintained in the absence of authenticated control messages. For example, in the absence of an authenticated “Hello” message, a virtual circuit in L2TP is eventually torn down. After authenticated control messages resume, another virtual circuit is built up. In the interim, a connection-based service is denied to a subscriber. In addition, valuable network resources, such as bandwidth, are consumed in breaking down one virtual circuit and then building another.

In some approaches, the configuration change is scheduled for a particular time when network traffic is minimal. A disadvantage of this approach is that it is difficult to coordinate a time of minimal network traffic when there are a large number of peers, peers are under control of different administrators, or peers are located in widely different global time-zones.

In another approach, instead of changing the secret used by control messages that maintain a virtual circuit, a second virtual circuit is established between the same two arbitrary nodes using a different secret value. Traffic is then diverted to the second virtual circuit and the first virtual circuit dissolves as “Hello” control messages are no longer sent for the first virtual circuit, or upon the countdown of a timer, or upon receipt of an explicit control message to shutdown the second circuit. A disadvantage of this approach is that excess network resources are consumed to set up the second virtual circuit. Also, network resources may not be sufficient to maintain two highly demanding virtual circuits simultaneously for even a short time.

In yet another approach, changes in control plane state and additional signaling are employed to indicate that a new shared secret is being distributed. For example, a “secret refresh” message is sent between peers to signal that a new secret is to be used. This requires changes to protocol state machines, creation of new control messages types to be sent and received, and synchronization between peers based on these new messages. The excess network resources consumed are a disadvantage of this approach.

In another approach, messages are authenticated using a public key infrastructure (PKI). A disadvantage of this approach is that a great deal of administrative and network resources are consumed in forming, distributing and using the public key system. Furthermore, the PKI system is designed for sending sensitive data over an untrusted network and does not take advantage of the efficiencies of a trusted domain. A further significant disadvantage is that using the PKI system requires a massive change to some protocols, such as L2TP, and extensive changes to the software and hardware already deployed.

Based on the foregoing, there is a clear need for techniques that allow the shared secret in a trusted domain to be changed that do not suffer the disadvantages of the prior art approaches. In particular, there is a need for techniques that allow a network administrator to change a shared secret for authentication of network protocol control messages within a trusted domain without requiring a secret transition time that is short compared to time between control messages everywhere on the network, without changing control plane state or using extra control plane signaling, and without building new virtual circuits.

The past approaches described in this section could be pursued, but are not necessarily approaches that have been previously conceived or pursued. Therefore, unless otherwise indicated herein, the approaches described in this section are not to be considered prior art to the claims in this application merely due to the presence of these approaches in this background section.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1A is a block diagram that illustrates a network, according to an embodiment;

FIG. 1B is a block diagram that illustrates a packet of data communicated over a network;

FIG. 2 is a flow diagram that illustrates at a high level a method for changing a shared secret in a trusted domain, according to an embodiment;

FIG. 3A is a flow diagram that illustrates a method for generating control messages at a network node using multiple shared secrets simultaneously in a trusted domain, according to an embodiment;

FIG. 3B is a flow diagram that illustrates a method for authenticating a control messages at a network node using multiple shared secrets simultaneously in a trusted domain, according to an embodiment;

FIG. 4A is a block diagram that illustrates peer network nodes in a trusted domain, according to an embodiment;

FIG. 4B is a block diagram that illustrates a control message packet communicated over a network, according to an embodiment; and

FIG. 5 is a block diagram that illustrates a computer system configured as a router upon which an embodiment of the invention may be implemented.

### DETAILED DESCRIPTION

Methods and apparati are described for changing a shared secret for authentication of network protocol control messages. In the following description, for the purposes of explanation, numerous specific details are set forth in order to provide a thorough understanding of the present invention. It will be apparent, however, to one skilled in the art that the present invention may be practiced without these specific details. In other instances, well-known structures and devices are shown in block diagram form in order to avoid unnecessarily obscuring the present invention.

1.0 Functional Overview

In various embodiments described herein, techniques are provided that allow a network administrator to change a shared secret for authentication of network protocol control messages within a trusted domain without requiring a secret transition time that is short compared to time between control messages, without changing control plane state or using extra control plane signaling, and without building new virtual circuits. These techniques allow one or more network administrators to change a shared secret in configuration data for multiple peers, even when the configuration data is manually controlled by those administrators, and even if the peers are distributed widely over the globe in all time zones.

In one set of embodiments, a method for changing a secret value used to authenticate network protocol control messages among network nodes in a trusted domain includes configuring each network node in the domain to use a first secret value to authenticate network protocol control messages among network nodes in the domain. After every network node in the domain has been configured with the first secret value, each network node in the domain is configured to use a different second secret value to authenticate network protocol control messages. After every network node has been configured with the second secret value, each network node in the domain is configured to no longer use the first secret value to authenticate network protocol control messages. Thus a configured secret value for authentication is changed from the first secret value to the second secret value while maintaining communication of network protocol control messages within the domain.

In some of these embodiments, the network protocol control messages authenticated using the first secret value are transmitted over the same control connection, such as the same virtual circuit, as the network protocol control messages authenticated using the second secret value.

In a second set of embodiments, a method for exchanging network protocol control messages among network nodes in a trusted domain enables the steps described above. A shared secret is received at a particular network node of a domain of network nodes. The shared secret data indicates a set of one or more secret values. Each secret value is shared among multiple network nodes in the domain. A network protocol control message is received at the particular network node. The network protocol control message includes a set of one or more cipher data fields. Each cipher data field is deciphered using a secret value shared among network nodes in the domain. It is determined whether any secret value in the first set deciphers any cipher data field in the second set. If it is determined that no secret value in the first set deciphers any cipher data field in the second set, then the network protocol control message is rejected. Either the set of secrets or the set of cipher data fields, or both, has more than one member. Each different member of a set with multiple members involves a different secret value.

In some embodiments of the second set of embodiments, the cipher data field is a digital signature. In some embodiments of the second set of embodiments, the domain of network nodes is made up of multiple routers. In some embodiments of the second set of embodiments, the network protocol control message is a link layer tunneling protocol control message. In some embodiments of the second set of embodiments, shared secret data for multiple network nodes of the domain is received at multiple different times that span a time duration greater than about one hour. In some embodiments of the second set of embodiments, the step of receiving shared secret data includes receiving manual input and receiving the shared secret data in response to the manual input.

In a third set of embodiments, a method for exchanging network protocol control messages among network nodes in a trusted domain includes receiving shared secret data at a first network node of a domain of network nodes. Shared secret data indicates multiple secret values. Each secret value is shared among multiple network nodes in the domain. A network protocol control message is generated that includes a corresponding number of cipher data fields. Each cipher data field is deciphered using a different one secret value of the multiple secret values. The network protocol control message is sent to a second network node in the domain.

In some embodiments of the third set of embodiments, the second network node is not in a first group of network nodes that shares a first secret value of the multiple secret values.

In other sets of embodiments, apparati, systems and computer-readable media perform steps of the above methods.

In the following description, embodiments are described in the context of control messages for the L2TP protocol; but the invention is not limited to this context. In some embodiments, the control messages are other data exchanged between members of a trusted domain using a shared secret, such as, but not limited to, control messages of other protocols in other networking layers.

2.0 Network Overview

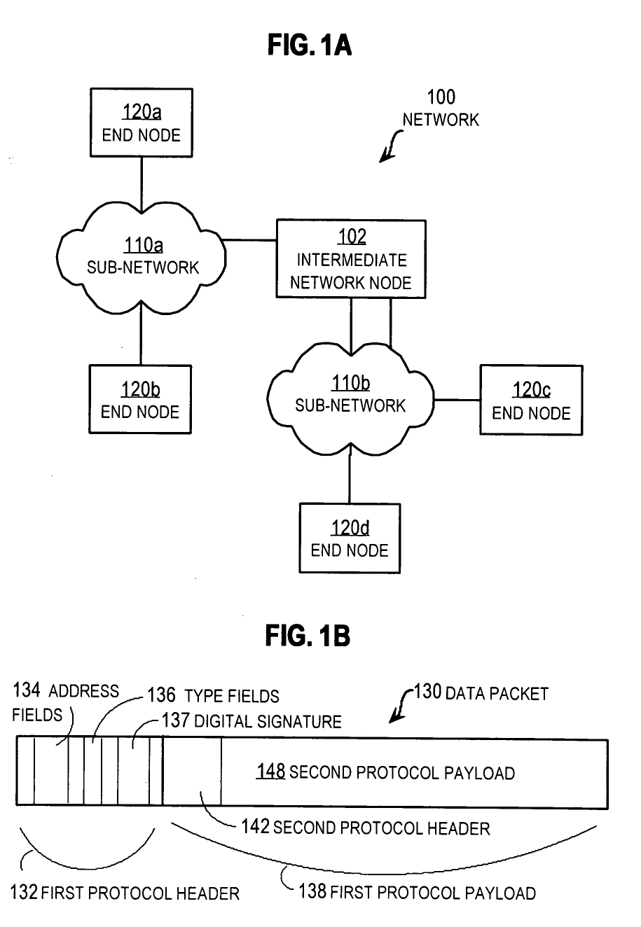

FIG. 1A is a block diagram that illustrates a network 100, according to an embodiment. A computer network is a geographically distributed collection of interconnected sub-networks (e.g., sub-networks 110a, 110b, collectively referenced hereinafter as sub-network 110) for transporting data between nodes, such as computers. A local area network (LAN) is an example of such a sub-network. The network's topology is defined by an arrangement of end nodes (e.g., end nodes 120a, 120b, 120c, 120d, collectively referenced hereinafter as end nodes 120) that communicate with one another, typically through one or more intermediate network nodes, e.g., intermediate network node 102, such as a router or switch, that facilitates routing data between end nodes 120 on different sub-networks. As used herein, an end node 120 is a node that is configured to originate or terminate communications over the network. In contrast, an intermediate network node 102 facilitates the passage of data between end nodes. Each sub-network 110b may include one or more intermediate network nodes. Although, for purposes of illustration, intermediate network node 102 is connected by one communication link to sub-network 110a and thereby to end nodes 120a, 120b and by two communication links to sub-network 110b and end nodes 120c, 120d, in other embodiments an intermediate network node 102 may be connected to more or fewer sub-networks 110 and directly or indirectly to more or fewer end nodes 120 and directly or indirectly to one or more other intermediate network nodes.

FIG. 1B is a block diagram that illustrates a packet 130 communicated over a network, such as network 100. Each packet typically comprises one or more payloads of data, e.g. payloads 138, 148, each encapsulated by at least one network header, e.g., headers 132, 142, respectively. For example, payloads are encapsulated by appending a header before the payload, sometimes called prepending a header, and sometimes by appending a tail after the payload. Each header 132, 142 is formatted in accordance with a network communication protocol; header 132 is formatted according to a first protocol and header 142 is formatted according to a second protocol. The header 142 for the second protocol is included within the payload 138 of the first protocol. The header for a protocol typically includes type fields that identify the protocol to which the header belongs and the next protocol in the payload, if any. For example, the header 132 for the first protocol includes type fields 136. The header for a protocol often includes a destination address or a source address, or both, for the information in the payload. For example, the header 132 for the first protocol includes address fields 134 where the source and receiver address for the first protocol is located within the packet 130. If the first protocol involves authentication then a cipher field, such as digital signature 137, is included in the first protocol header 132 or payload. As described above, a packet's network headers include at least a data-link (layer 2) header, and possibly an internetwork (layer 3) header and possibly a transport (layer 4) header.

The physical (layer 1) header defines the electrical, mechanical and procedural mechanisms for proper capture of the Ethernet frame, but is not captured by a Media Access Controller.

The data-link header provides information for transmitting the packet over a particular physical link (i.e., a communication medium), such as a point-to-point link, Ethernet link, wireless link, optical link, etc. An intermediate network node typically contains multiple physical links with multiple different nodes. To that end, the data-link header may specify a pair of “source” and “destination” network interfaces that are connected by the physical link. A network interface contains the mechanical, electrical and signaling circuitry and logic used to couple a network node to one or more physical links. A network interface is often associated with a hardware-specific address, known as a media access control (MAC) address. Accordingly, the source and destination network interfaces in the data-link header are typically represented as source and destination MAC addresses. The data-link header may also store flow control, frame synchronization and error checking information used to manage data transmissions over the physical link. The L2TP protocol and header are described in more detail below.

The internetwork header provides information defining the source and destination address within the computer network. Notably, the path may span multiple physical links. The internetwork header may be formatted according to the Internet Protocol (IP), which specifies IP addresses of both a source and destination node at the end points of the logical path. Thus, the packet may “hop” from node to node along its logical path until it reaches the end node assigned to the destination IP address stored in the packet's internetwork header. After each hop, the source and destination MAC addresses in the packet's data-link header may be updated, as necessary. However, the source and destination IP addresses typically remain unchanged as the packet is transferred from link to link in the network.

The transport header provides information for ensuring that the packet is reliably transmitted from the source node to the destination node. The transport header typically includes, among other things, source and destination port numbers that respectively identify particular software applications executing in the source and destination end nodes. More specifically, the packet is generated in the source node by a software application assigned to the source port number. Then, the packet is forwarded to the destination node and directed to the software application assigned to the destination port number. The transport header also may include error-checking information (e.g., a checksum) and other data-flow control information. For instance, in connection-oriented transport protocols such as the Transmission Control Protocol (TCP), the transport header may store sequencing information that indicates the packet's relative position in a transmitted stream of packets.

The L2TP protocol is a link layer (layer 2) protocol established to provide a persistent virtual circuit as a tunnel between two end nodes of a trusted sub-network. In network parlance a tunnel for data is simply a protocol that encapsulates that data. L2TP facilitates the tunneling of point to point protocol (PPP) packets across an intervening network in a way that is as transparent as possible to both end-users and applications. Using L2TP tunneling, an Internet Service Provider (ISP), or other access service, can create a virtual tunnel to link customer's remote sites or remote users with corporate home networks. More recent versions of L2TP facilitates tunneling of a number of data link types, including, but no limited to, PPP, Frame Relay, Asynchronous Transfer Mode (ATM), High Level Data Link Control (HDLC) and Ethernet.

For example, when tunneling PPP, a L2TP access concentrator (LAC) located at the ISP's point of presence (POP), e.g., intermediate network node 102 on an IP sub-network 110b, exchanges PPP messages with remote users, e.g. a user at end node 120a, and communicates by way of L2TP requests and responses with the customer's L2TP network server (LNS), e.g., end node 120c, to set up tunnels through IP sub-network 110b. In more recent versions of L2TP, the peers, such as the POP102 and LNS 120c, are called L2TP Control Connection Endpoint (LCCE). L2TP passes protocol-level packets through the virtual tunnel between end points, e.g., 120a, 120c, of a point-to-point connection. Frames from remote users (e.g., from user at end node 120a) are accepted by the ISP's POP (e.g., 102), stripped of any linked framing or transparency bytes, encapsulated in L2TP and forwarded over the appropriate tunnel. The customer's home gateway LNS 120c (sometimes referred to as Customer Premises Equipment, CPE) accepts these L2TP frames, strips the L2TP encapsulation, and processes the incoming frames for the appropriate interface. The L2TP protocol is described in Internet Engineering Task Force (IETF) Request for Comment (RFC) number 2661 found at the IETF world wide web page, ieft.org, in the directory named rtf; the entire contents of RFC2661 are hereby incorporated by reference as if fully set forth herein.

The routers in the IP network (e.g., sub-network 110b) belonging to the ISP must support the L2TP protocol. The links and hops that constitute a virtual circuit for the tunnel are associated with a particular tunnel based on L2TP data stored at each router in the IP network (e.g., sub-network 110b). This L2TP data is exchanged and kept active by exchanging L2TP control messages among the routers within the IP network belonging to the ISP (e.g., among the routers in the sub-network 110b).

A L2TP control message is structured much like data packet 130, where the first protocol header 132 is the L2TP header and the type fields 136 indicate a control message. However, the payload 138 does not contain data transmitted from end nodes (e.g., 120a, 120c) but instead contains L2TP data used to form and maintain a L2TP tunnel and any virtual circuit used by the tunnel.

Since all the routers in sub-network 10b belong to the same ISP, they constitute a trusted domain of network nodes that can share secrets. The shared secret is used to digitally sign each control message to ensure that the control message originated from one of the routers in sub-network 110b that belong to the ISP rather than originating in some other node not controlled by the ISP. For example, the secret value shared by routers of the ISP is used with the payload 138 as input to the one-way hash function to produce a 96 bit digital signature that is included in the digital signature field 137. If a router that does not posses the shared secret attempts to send a control message, the receiving router will discover that the contents of the digital signature field 137 does not agree with a value computed by the receiving router based on the payload 138 and the shared secret value.

3.0 Method for Changing Secrets in Trusted Domain

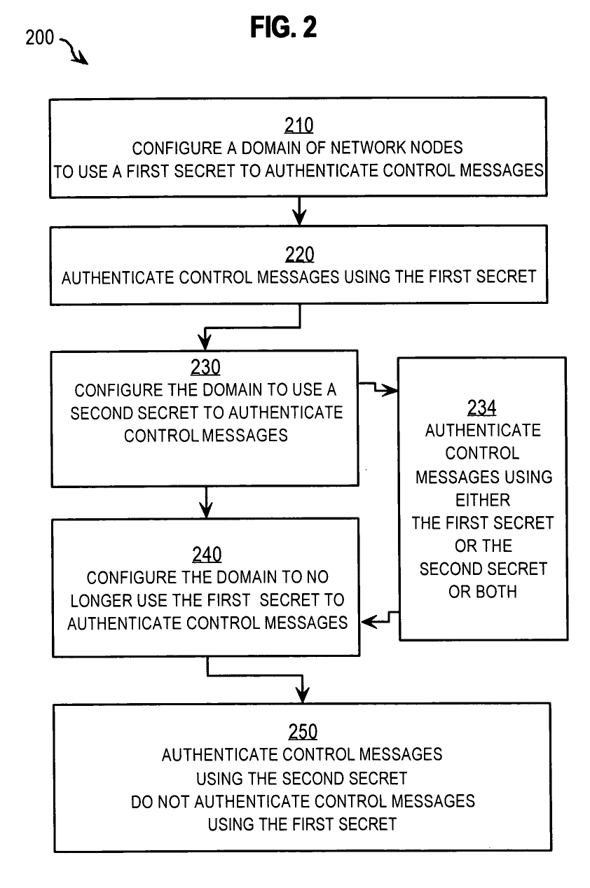

FIG. 2 is a flow diagram that illustrates at a high level a method 200 for changing a shared secret in a trusted domain, according to an embodiment. For example, version 3 of L2TP (L2TPv3) is an emerging protocol that includes an embodiment of method 200 and is being prepared at the time of this writing as IETF RFC 3931.

In step 210, all the network nodes in a trusted domain are configured to use a first secret value to authenticate control messages. For example, a network administrator stores the first secret value with the configuration data one by one for all the routers in sub-network 110b belonging to a particular ISP. Any method for providing configuration data to network nodes (also called “provisioning” the network nodes) may be used. In some embodiments, with many administrators or far-flung network nodes, the duration of this step may exceed one to several hours.

In step 220, control messages are authenticated using the first secret. For example, a first router in sub-network 110b generates a control message using the first shared secret value and the payload of the control message as input to a one-way hash function to produce a 96-bit digital signature. The first router places the digital signature in a field of the control message, e.g., into digital signature field 137. The first router sends the control message to a different second router in the sub-network 110b. The second router uses the first secret shared value and the payload of the control message to generate a test digital signature. If the test digital signature matches the digital signature in the message, e.g., if the test digital signature matches the contents of field 137, then the sending router is authenticated and the message is verified.

In step 230, all the network nodes in the trusted domain are reconfigured to use a second secret also to authenticate control messages. For example, a network administrator stores the second secret value with the configuration data one by one for all the routers in sub-network 110b belonging to the ISP. As described above, any provisioning method for providing configuration data to network nodes may be used. In some embodiments, as described above, the duration of this step may exceed one to several hours. In some embodiments, in an effort to reduce the impact on users of the network protocol, the network nodes configured during any hour are based on the time zone where the router is located or on another parameter, as convenient. The choice of which nodes to reconfigure is made in an effort to minimize the use of network resources during periods of peak network traffic when network resources are scarce and balance such loads with the availability of human administrators to make the configuration changes. For example, in some embodiments, the network reconfiguration is scheduled to occur at 3 AM in each time zone.

In step 240, after all the network nodes in the trusted domain are reconfigured to use the second secret in step 230, the nodes are reconfigured again to stop using the first secret. For example, a network administrator removes the first secret value from the configuration data one by one for all the routers in sub-network 110b belonging to the ISP. As described above, any provisioning method for providing configuration data to network nodes may be used. In some embodiments, as described above, the duration of this step may exceed one to several hours. In some embodiments, as described above, the network nodes are reconfigured in an order that is convenient, such as to reduce the demand for network resources during periods of peak traffic.

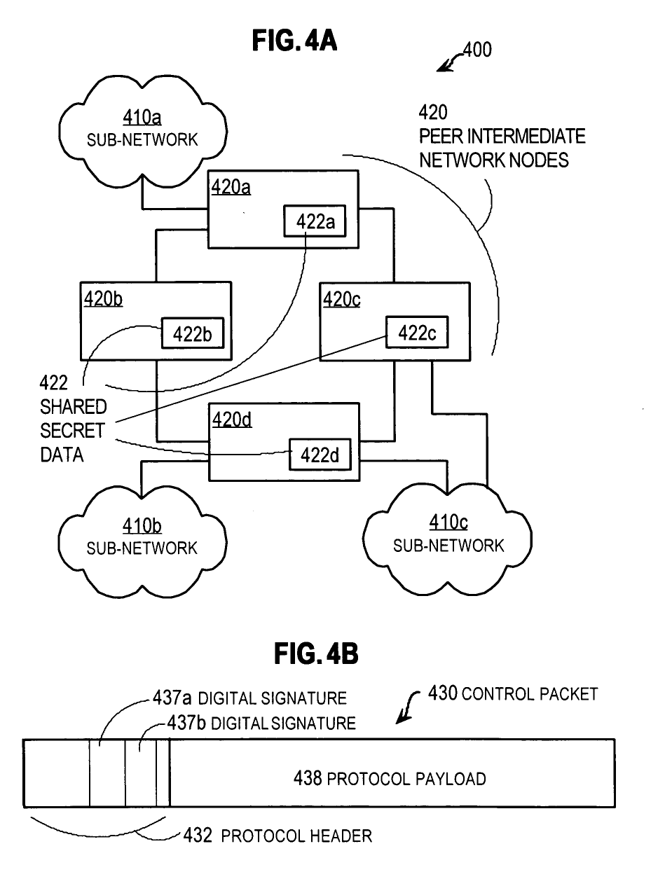

In step 234, after the beginning of step 230 and before the end of step 240, control messages are authenticated using the first secret or the second secret or both. This is done because not all nodes yet have been configured with the second secret after the start of step 230; and not all nodes still retain the first secret after the start of step 240. Thus neither the first secret nor the second secret can be assuredly known at both the sending and receiving nodes of a particular control message. By allowing either secret to authenticate a control message, control messages can be delivered during the transition without the disadvantages of prior art approaches. Because step 240 does not begin until substantially all of step 230 is completed, no node loses the capacity to authenticate with the first secret until every node has received the capacity to authenticate with the second secret. A method for authenticating control messages using either of two or more secrets simultaneously is described in more detail in the next section with reference to FIG. 4A and FIG. 4B. The methods described in that section do not require any special signaling to inform the nodes that a change in secrets is commencing or finishing.

In step 250, control messages are authenticated using the second secret but not the first secret. In the example embodiment described above, after step 240, no node in the trusted domain retains data about the first secret. The shared secret has been changed without interrupting the flow of control messages or control state of any node.

4.0 Method for Using Multiple Simultaneous Secrets in Domain

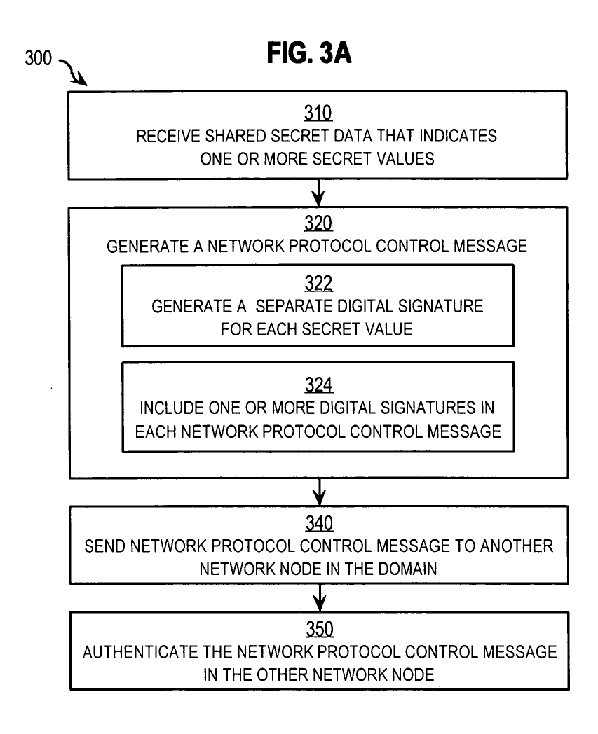

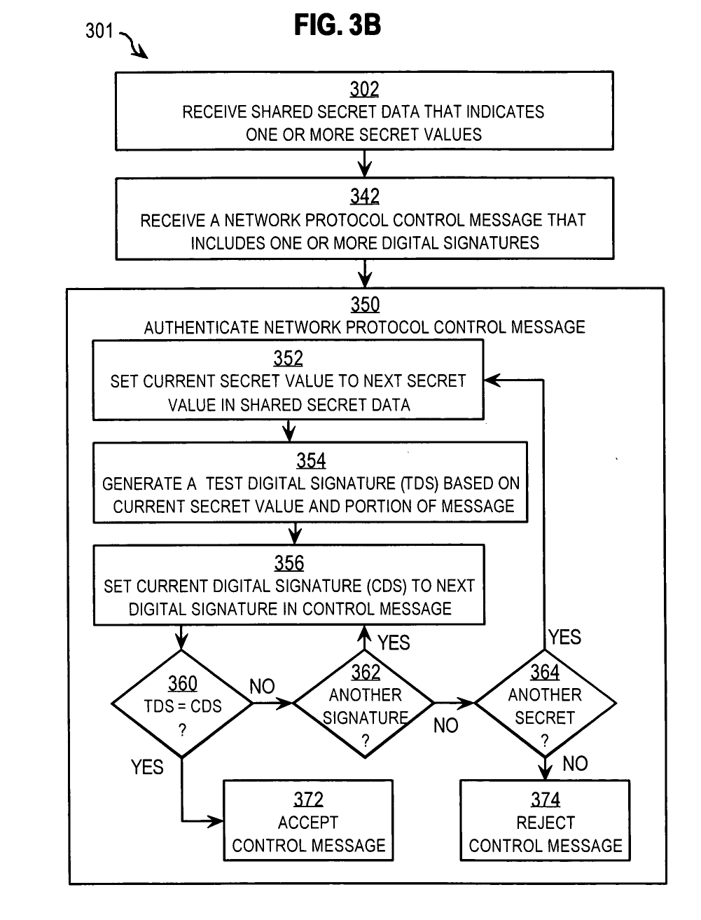

FIG. 3A is a flow diagram that illustrates a method for generating control messages at a network node using multiple shared secrets simultaneously in a trusted domain, according to an embodiment. Although steps are shown in FIG. 3A and FIG. 3B in a particular order for purposes of illustration, in other embodiments, the steps may be performed in a different order or overlapping in time, or one or more steps may be omitted. For example, step 310 to receive shared secret data and step 320 to generate a control message are performed repeatedly. Therefore, some messages are generated after some shared secret data is received and before changes in shared secret data are received, as depicted, for example, in FIG. 2.

In step 310, shared secret data is received that indicates one or more secret values. Prior art approaches receive only one shared secret value for control message authentication. Any method may be used to receive the shared secret data. In some embodiments, the shared secret data is stored in files or a database accessible only to the network node. In some embodiments, the network administrator inputs data to indicate the shared secret values, either in response to prompts from a provisioning process or independently of prompts. In some embodiments, the manual input indicates the actual secret values. In some embodiments, the manual input is simply a command to deliver to the particular node one or more secret values already stored on the network. In some embodiments, the shared secret data is input directly to a terminal connected to the node. In some embodiments, the shared secret is communicated to the node over a communication link or network of communication links. In the illustrated embodiments, the shared secret data is received incrementally as different secret values are added or removed from the shared secret data in storage. In some embodiments, after provisioning based on manual input, the shared secret data is stored locally on the node, as illustrated in FIG. 4A.

FIG. 4A is a block diagram that illustrates peer network nodes 420 in a trusted domain 400, according to an embodiment. The trusted domain 400 includes four peer intermediate network nodes 420a, 420b, 420c, 420d among the peer intermediate nodes 420. The peer intermediate network nodes 420, e.g. routers, are connected to each other by direct communication links and by some links to multiple sub-networks 410a, 410b, 410c. In other embodiments more or fewer peer network nodes and sub-networks are included.

As shown in FIG. 4A, each peer node 420 includes shared secret data, such as on a persistent memory device at the node 420. In the illustrated embodiment, the peer nodes 420a, 420b, 420c, 420d hold shared secret data 422a, 422b, 422c, 422d, collectively referenced hereinafter as shared secret data 422. Because it takes time to provision these peer nodes 420 with shared secret data 422, the contents of the shared secret data 422a, 422b, 422c, 422d are not always the same at a particular time. For example, during step 230 of FIG. 2, all the nodes 420 include the first secret value in the shared secret data 422a, 422b, 422c, 422d, but only some nodes include the second secret value in the shared secret data 422. Similarly, during step 240 of FIG. 2, all the nodes 420 include the second secret value in the shared secret data 422a, 422b, 422c, 422d, but some nodes have had the first secret value removed. For purposes of illustration, it is assumed that only routers 420a and 420b have been provisioned during step 230, so that shared secret data 422a, 422b include both the first secret value and the second secret value, but shared secret data 422c, 422d include only the first secret value.

In step 320 a network protocol control message is generated. Step 320 includes steps 322 and 324. In step 322, a separate digital signature is generated for each secret value. Thus the number of digital signatures corresponds to the number of secret values in the shared secret data. For example, if the digital message is generated during step 230 by a particular router, e.g., router 420c, that has the first secret value but not the second secret value, then only one digital signature is produced in step 322. However, if the control message is generated during step 230 by a particular router, e.g., router 420a, that has the first secret value and the second secret value, then two digital signatures are produced in step 322.

In other embodiments, ciphered data other than a digital signature is generated that can be used to authenticate or verify the contents of the control message. The term cipher data is used to mean any data that is deciphered using a secret value shared among network nodes in a trusted domain. By this definition, both a digital signature and an encrypted message, among others, are included in cipher data. For example, in some embodiments the payload of the control message is encrypted in such a way that the shared secret is needed to decrypt the message and produce valid control data.

In step 324, all the digital signatures generated in step 322 are included in the control message. The network protocol using the control message should be modified to allow two or more digital signatures. Many protocols allow for flexible formatting so that optional fields can be inserted in a header. A second digital signature, when produced, is included as such an optional field in some embodiments. For example, router 420c produces a control message with one digital signature field, as in the prior art, such as field 137 in FIG. 1. However, router 420c produces a control message with two digital signature fields, as shown in FIG. 4B.

FIG. 4B is a block diagram that illustrates a control message packet 430 communicated over a network, according to an embodiment. The control message packet 430 includes a protocol header 432 and a protocol payload 438. The protocol header includes two digital signature fields 437a, 437b (collectively referenced hereinafter as digital signature fields 437). In some embodiments, the second digital signature field 437b is an optional field allowed by the protocol. In some embodiments, the protocol is modified to allow a second or more digital signatures. For example, L2TP is modified in L2TPv3 to allow two or more digital signatures, according to an embodiment of the invention. L2TPv3 is made up of “Attribute Value Pairs (AVP)”—the Attribute describes what value follows and the length of the value, and the Value is a field of the specified length that holds the value itself. For the digital signature, two (or more) of these AVPs for digital signatures occur in a given message. L2TPv3 places some restrictions on where the AVP can be in the message to strike a balance in processing messages, because the more freedom allowed in placing the AVPs, the more difficult is the processing.

Referring again to FIG. 3A, in step 340, the control message is sent to another network node in the trusted domain. For example, node 420b sends a L2TPv3 control message 430 with two digital signatures to node 420a and node 420b. Similarly, node 420c sends a different L2TPv3 control message that is similar to a standard L2TP control message, with only one digital signature, like data packet 130, to the same two nodes 420a, 420d.

In step 350, the receiving node authenticates the control message. For example, node 420a authenticates message 430 with two digital signatures received from node 420b and authenticates a message with a single digital signature, like data packet 130, received from node 420c. Similarly, node 420d authenticates message 430 with two digital signatures received from node 420b and authenticates a message with a single digital signature, like data packet 130, received from node 420c. More details about step 350 are described below with reference to FIG. 3B.

FIG. 3B is a flow diagram that illustrates a method 301 for authenticating a control message received at a network node using multiple shared secrets simultaneously in a trusted domain, according to an embodiment.

In step 302, the network node receives shared secret data that indicates one or more secret values. As described above for step 310 at the sending node, any method may be used to receive the shared secret data. Prior art approaches receive only one secret value for control message authentication. As described above for various embodiments, the shared secret data is stored in files or a database accessible only to the network node; the network administrator inputs data to indicate the shared secrets, either in response to prompts from a provisioning process or independently of prompts. In some embodiments, the manual input indicates the actual secret values; and in some embodiments, the manual input is simply a command to deliver the secret value already stored on the network to the particular node. In some embodiments, the shared secret data is input directly to a terminal connected to the node. In some embodiments, the shared secret is communicated to the node over a communication link or network of communication links. In some embodiments, the shared secret data is received incrementally as different secret values are added or removed from the shared secret data in storage. In some embodiments, after provisioning based on manual input, the shared secret data is stored locally on the node, as illustrated in FIG. 4A. For example, during step 230, router 420a is provisioned with the second secret value. Therefore, both secret values are stored in its shared secret data 422a. At the same time, router 420d is not yet provisioned with the second secret value. Therefore, only the first secret value is stored in its shared secret data 422d.

In step 342, a control message is received that includes one or more fields of cipher data, such as a digital signature or encrypted message. For example, in response to control messages sent from routers 420b, 420c during step 340, router 420a receives from router 420c a L2TPv3 control message with one digital signature, and receives from router 420b a L2TPv3 control message with two digital signatures. Similarly, router 420d receives from router 420c a L2TPv3 control message with one digital signature, and receives from router 420b a L2TPv3 control message with two digital signatures.

In step 350, as described above, the receiving node authenticates the control message sent during step 340. Any method may be used to authenticate control messages with two or more cipher fields. In the illustrated embodiment, step 350 includes step 352, 354, 356, 360, 362, 364, 372, 374.

In step 352, a current secret value is set to the next secret value in the shared data. The first time that step 352 is executed in response to a received control message, the next secret value is the secret value at a beginning of a stored sequence of one or more secret values. During subsequent executions of step 352, if any, the next secret value is taken as the next secret value in the stored sequence, if any. For example, during the first execution of step 352, the current secret value is set to the first secret value in both receiving routers 420a, 420b.

In step 354, a test digital signature (TDS) is generated using the agreed-upon portion of the message and the current secret value. For example, when the current secret value is the first secret value, a value DSb1 is generated for the TDS at both routers 420a, 420d. The value DSb1 represents the result obtained by using the first secret value and the payload of the L2TPv3 message received from router 420b as input to the one-way hash function. Similarly, a value of DSc1 is generated for the TDS at both routers 420a, 420d by using the first secret value and the payload of the L2TP message received from router 420c as input to the one-way hash function.

In other embodiments, step 354 is replaced with a step to generate other test cipher data using the current secret value, or is omitted. For example, in embodiments in which a payload is decrypted using a secret value, step 354 is omitted.

In step 356, a current digital signature (CDS) is set to the next digital signature in the received control message. The first time that step 356 is executed in response to a received control message, the next digital signature is the digital signature closest to one end of the received control message. During subsequent executions of step 352, if any, the next digital signature is taken as the unused digital signature adjacent to the last digital signature selected, if any. For example, during step 356, the current digital signature CDS is set to the contents of the only digital signature field in the message received from router 420c, e.g., field 137. For the message from 420b, the current digital signature CDS is first set to the contents of digital signature field 437b closest to the end of the control message received from router 420b. On a subsequent execution of step 356, CDS is set to the contents of the adjacent digital signature 437a. For purposes of illustration, it is assumed that the contents of digital signature field 437b is DSb2, a digital signature based on the payload of the message from router 420b and on the second secret value. Similarly, it is assumed that the contents of digital signature field 437a is DSb1, a digital signature based on the payload of the message from router 420b and on the first secret value.

In other embodiments, step 356 is replaced with a step to set the current cipher data to the next cipher data. For example, in embodiments in which a payload is decrypted using a secret value, step 356 selects one of the one or more encrypted messages as the current cipher data.

In step 360 it is determined whether the test digital signature is equal to the current digital signature. If so, then the control message is authenticated and control passes to step 372 to accept the control message and use its contents to implement an aspect of the protocol. For example, a “Hello” message is accepted and processed in the L2TP peer. If not, control passes to step 362 and following steps to determine if a match can be made with another combination of secret value and digital signature.

For example, in response to a control message sent from router 420c during step 340, router 420a receives a L2TPv3 control message with one digital signature. On the first pass through step 360, the current secret value is the first secret value and the test digital signature (TDS) has a value of DSc1. The current digital signature (CDS) also has a value DSc1, as described above for step 356. Thus TDS is equal to CDS and control passes to step 372 to accept the control message.

However, in response to a control message sent from router 420b during step 340, router 420a receives a L2TPv3 control message with two digital signatures. On the first pass through step 360, the current secret value is the first secret value and the test digital signature (TDS) has a value of DSb1. The current digital signature (CDS) has a value DSb2, as described above for step 356. Thus TDS is not equal to CDS and control passes to step 362.

In other embodiments, step 360 is replaced with a step to determine if the current cipher data produces a correct result using the current secret value. For example, in embodiments in which a payload is decrypted using a secret value, step 360 decrypts the current cipher data and determines whether the decrypted message is valid, e.g., gives a value in a valid range for each of one or more parameters.

In step 362, it is determined whether another digital signature is included in the received control message. If not, control passes to step 364. If there is another digital signature, control passes back to step 356 to set the current digital signature to the next digital signature in the control message.

For example, while processing the control message sent from router 420b to router 420a control passes to step 362. On the first pass through step 362, it is determined that there is another digital signature and control passes back to step 356. In step 356 the current digital signature is set equal to the contents of digital signature field 437a, which is DSb1. This matches the value of the test digital signature (TDS) as determined during step 360, and control passes eventually to step 372 to accept the message.

In other embodiments, step 362 is replaced with a step to determine if there is another cipher data field in the received control message. For example, in embodiments in which a payload is decrypted using a secret value, it is determined in step 362 whether there is another encrypted message in the control message.

In step 364, it is determined whether another secret is included in the shared secret data. If not, control passes to step 374 to reject the control message and not respond to the contents of its payload. If there is another secret, control passes back to step 352 to set the current secret value to the next secret value in the shared secret data stored at the receiving node.

For example, if a spoofed control message is received at router 420a with a digital signature based on an incorrect or abandoned secret, the digital signature will not be matched in step 360 to the test digital signature generated with the first secret value. The absence of a second signature causes control to pass to step 364. At step 364, the router passes control to step 352 to use the second secret value. Again, the digital signature is not matched in step 360 to the test digital signature generated with the second secret value. The absence of a second signature again causes control to pass to step 364. At step 364, it is determined that there are no further secret values, and control passes to step 374 to reject the control message.

The method 350 also produces the desired result after step 240 begins. At routers where the first secret value has been removed and only the second secret value remains in the shared secret data 422, every router generates a control message that includes a digital signature based on the second secret value. Some routers are also still including a digital signature based on the first secret value. The second secret value stored in all shared secret data causes these routers to authenticate each of these control messages.

An advantage of the illustrated embodiment is that no special signaling is used to start using one secret and stop using the other secret. The addition or removal of secret values to the shared secret data stored at a router automatically leads to the desired behavior at the router.

5.0 Implementation Mechanisms—Hardware Overview

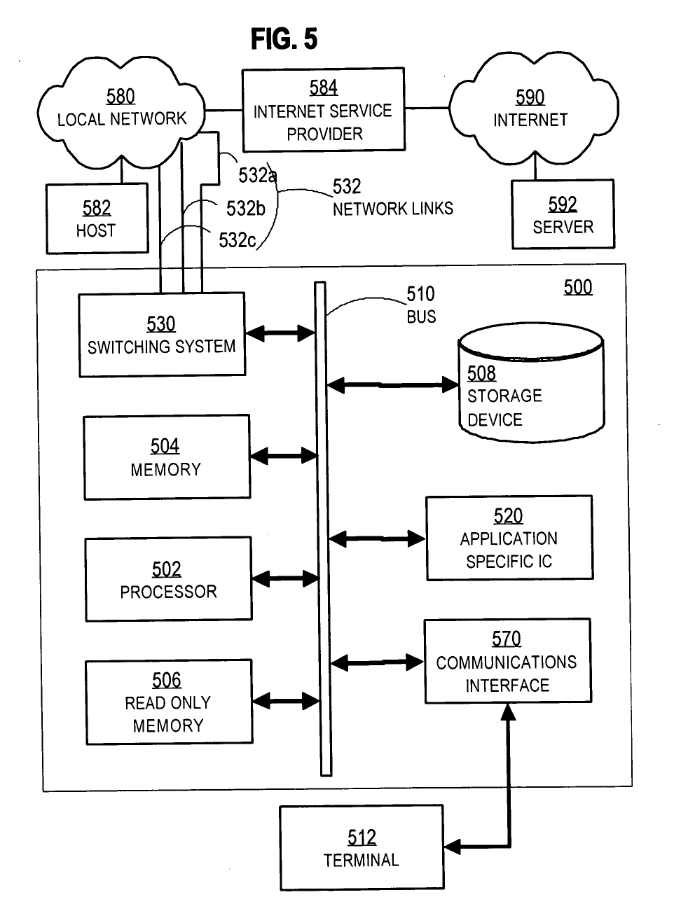

FIG. 5 is a block diagram that illustrates a computer system 500 upon which an embodiment of the invention may be implemented. The preferred embodiment is implemented using one or more computer programs running on a network element such as a router device. Thus, in this embodiment, the computer system 500 is a router.

Computer system 500 includes a communication mechanism such as a bus 510 for passing information between other internal and external components of the computer system 500. Information is represented as physical signals of a measurable phenomenon, typically electric voltages, but including, in other embodiments, such phenomena as magnetic, electromagnetic, pressure, chemical, molecular atomic and quantum interactions. For example, north and south magnetic fields, or a zero and non-zero electric voltage, represent two states (0, 1) of a binary digit (bit). A sequence of binary digits constitutes digital data that is used to represent a number or code for a character. A bus 510 includes many parallel conductors of information so that information is transferred quickly among devices coup led to the bus 510. One or more processors 502 for processing information are coupled with the bus 510. A processor 502 performs a set of operations on information. The set of operations include bringing information in from the bus 510 and placing information on the bus 510. The set of operations also typically include comparing two or more units of information, shifting positions of units of information, and combining two or more units of information, such as by addition or multiplication. A sequence of operations to be executed by the processor 502 constitute computer instructions.

Computer system 500 also includes a memory 504 coupled to bus 510. The memory 504, such as a random access memory (RAM) or other dynamic storage device, stores information including computer instructions. Dynamic memory allows information stored therein to be changed by the computer system 500. RAM allows a unit of information stored at a location called a memory address to be stored and retrieved independently of information at neighboring addresses. The memory 504 is also used by the processor 502 to store temporary values during execution of computer instructions. The computer system 500 also includes a read only memory (ROM) 506 or other static storage device coupled to the bus 510 for storing static information, including instructions, that is not changed by the computer system 500. Also coupled to bus 510 is a non-volatile (persistent) storage device 508, such as a magnetic disk or optical disk, for storing information, including instructions, that persists even when the computer system 500 is turned off or otherwise loses power.

The term computer-readable medium is used herein to refer to any medium that participates in providing information to processor 502, including instructions for execution. Such a medium may take many forms, including, but not limited to, nonvolatile media, volatile media and transmission media. Nonvolatile media include, for example, optical or magnetic disks, such as storage device 508. Volatile media include, for example, dynamic memory 504. Transmission media include, for example, coaxial cables, copper wire, fiber optic cables, and waves that travel through space without wires or cables, such as acoustic waves and electromagnetic waves, including radio, optical and infrared waves. Signals that are transmitted over transmission media are herein called carrier waves.

Common forms of computer-readable media include, for example, a floppy disk, a flexible disk, a hard disk, a magnetic tape or any other magnetic medium, a compact disk ROM (CD-ROM), a digital video disk (DVD) or any other optical medium, punch cards, paper tape, or any other physical medium with patterns of holes, a RAM, a programmable ROM (PROM), an erasable PROM (EPROM), a FLASH-EPROM, or any other memory chip or cartridge, a carrier wave, or any other medium from which a computer can read.

Information, including instructions, is provided to the bus 510 for use by the processor from an external terminal 512, such as a terminal with a keyboard containing alphanumeric keys operated by a human user, or a sensor. A sensor detects conditions in its vicinity and transforms those detections into signals compatible with the signals used to represent information in computer system 500. Other external components of terminal 512 coupled to bus 510, used primarily for interacting with humans, include a display device, such as a cathode ray tube (CRT) or a liquid crystal display (LCD) or a plasma screen, for presenting images, and a pointing device, such as a mouse or a trackball or cursor direction keys, for controlling a position of a small cursor image presented on the display and issuing commands associated with graphical elements presented on the display of terminal 512. In some embodiments, terminal 512 is omitted.

Computer system 500 also includes one or more instances of a communications interface 570 coupled to bus 510. Communication interface 570 provides a two-way communication coupling to a variety of external devices that operate with their own processors, such as printers, scanners, external disks, and terminal 512. Firmware or software running in the computer system 500 provides a terminal interface or character-based command interface so that external commands can be given to the computer system. For example, communication interface 570 may be a parallel port or a serial port such as an RS-232 or RS-422 interface, or a universal serial bus (USB) port on a personal computer. In some embodiments, communications interface 570 is an integrated services digital network (ISDN) card or a digital subscriber line (DSL) card or a telephone modem that provides an information communication connection to a corresponding type of telephone line. In some embodiments, a communication interface 570 is a cable modem that converts signals on bus 510 into signals for a communication connection over a coaxial cable or into optical signals for a communication connection over a fiber optic cable. As another example, communications interface 570 may be a local area network (LAN) card to provide a data communication connection to a compatible LAN, such as Ethernet. Wireless links may also be implemented. For wireless links, the communications interface 570 sends and receives electrical, acoustic or electromagnetic signals, including infrared and optical signals, which carry information streams, such as digital data. Such signals are examples of carrier waves

In the illustrated embodiment, special purpose hardware, such as an application specific integrated circuit (IC) 520, is coupled to bus 510. The special purpose hardware is configured to perform operations not performed by processor 502 quickly enough for special purposes. Examples of application specific ICs include graphics accelerator cards for generating images for display, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

In the illustrated computer used as a router, the computer system 500 includes switching system 530 as special purpose hardware for switching information for flow over a network. Switching system 530 typically includes multiple communications interfaces, such as communications interface 570, for coupling to multiple other devices. In general, each coupling is with a network link 532 that is connected to another device in or attached to a network, such as local network 580 in the illustrated embodiment, to which a variety of external devices with their own processors are connected. In some embodiments an input interface or an output interface or both are linked to each of one or more external network elements. Although three network links 532a, 532b, 532c are included in network links 532 in the illustrated embodiment, in other embodiments, more or fewer links are connected to switching system 530. Network links 532 typically provides information communication through one or more networks to other devices that use or process the information. For example, network link 532b may provide a connection through local network 580 to a host computer 582 or to equipment 584 operated by an Internet Service Provider (ISP). ISP equipment 584 in turn provides data communication services through the public, world-wide packet-switching communication network of networks now commonly referred to as the Internet 590. A computer called a server 592 connected to the Internet provides a service in response to information received over the Internet. For example, server 592 provides routing information for use with switching system 530.

The switching system 530 includes logic and circuitry configured to perform switching functions associated with passing information among elements of network 580, including passing information received along one network link, e.g. 532a, as output on the same or different network link, e.g., 532c. The switching system 530 switches information traffic arriving on an input interface to an output interface according to pre-determined protocols and conventions that are well known. In some embodiments, switching system 530 includes its own processor and memory to perform some of the switching functions in software. In some embodiments, switching system 530 relies on processor 502, memory 504, ROM 506, storage 508, or some combination, to perform one or more switching functions in software. For example, switching system 530, in cooperation with processor 504 implementing a particular protocol, can determine a destination of a packet of data arriving on input interface on link 532a and send it to the correct destination using output interface on link 532c. The destinations may include host 582, server 592, other terminal devices connected to local network 580 or Internet 590, or other routing and switching devices in local network 580 or Internet 590.

The invention is related to the use of computer system 500 for implementing the techniques described herein. According to one embodiment of the invention, those techniques are performed by computer system 500 in response to processor 502 executing one or more sequences of one or more instructions contained in memory 504. Such instructions, also called software and program code, may be read into memory 504 from another computer-readable medium such as storage device 508. Execution of the sequences of instructions contained in memory 504 causes processor 502 to perform the method steps described herein. In alternative embodiments, hardware, such as application specific integrated circuit 520 and circuits in switching system 530, may be used in place of or in combination with software to implement the invention. Thus, embodiments of the invention are not limited to any specific combination of hardware and software.

The signals transmitted over network link 532 and other networks through communications interfaces such as interface 570, which carry information to and from computer system 500, are exemplary forms of carrier waves. Computer system 500 can send and receive information, including program code, through the networks 580, 590 among others, through network links 532 and communications interfaces such as interface 570. In an example using the Internet 590, a server 592 transmits program code for a particular application, requested by a message sent from computer 500, through Internet 590, ISP equipment 584, local network 580 and network link 532b through communications interface in switching system 530. The received code may be executed by processor 502 or switching system 530 as it is received, or may be stored in storage device 508 or other non-volatile storage for later execution, or both. In this manner, computer system 500 may obtain application program code in the form of a carrier wave.

Various forms of computer readable media may be involved in carrying one or more sequence of instructions or data or both to processor 502 for execution. For example, instructions and data may initially be carried on a magnetic disk of a remote computer such as host 582. The remote computer loads the instructions and data into its dynamic memory and sends the instructions and data over a telephone line using a modem. A modem local to the computer system 500 receives the instructions and data on a telephone line and uses an infra-red transmitter to convert the instructions and data to an infra-red signal, a carrier wave serving as the network link 532b. An infrared detector serving as communications interface in switching system 530 receives the instructions and data carried in the infrared signal and places information representing the instructions and data onto bus 510. Bus 510 carries the information to memory 504 from which processor 502 retrieves and executes the instructions using some of the data sent with the instructions. The instructions and data received in memory 504 may optionally be stored on storage device 508, either before or after execution by the processor 502 or switching system 530.

5.0 Extensions and Alternatives

In the foregoing specification, the invention has been described with reference to specific embodiments thereof. It will, however, be evident that various modifications and changes may be made thereto without departing from the broader spirit and scope of the invention. The specification and drawings are, accordingly, to be regarded in an illustrative rather than a restrictive sense.

What is claimed is:

1. A method for exchanging network protocol control messages among network nodes in a trusted domain comprising the steps of:
receiving, at a particular network node of a domain plurality of network nodes, shared secret data that indicates a first set of one or more secret values, wherein each secret value is shared among a plurality of network nodes in the domain plurality;
receiving, at the particular network node, a network protocol control message that includes a second set of one or more cipher data fields, wherein each cipher data field is deciphered using a secret value shared among a plurality of network nodes in the domain plurality;
determining whether any secret value in the first set deciphers any cipher data field in the second set; and
if it is determined that no secret value in the first set deciphers any cipher data field in the second set, then rejecting the network protocol control message,
wherein at least one of the first set and the second set has a plurality of members, and each different member of the plurality of members in one set involves a different secret value.

2. The method as recited in claim 1, wherein:
the network protocol control message also includes message data different from the second set of one or more cipher data fields;
each cipher data field of the second set is a digital signature produced as a particular function of the message data and a secret value associated with the cipher data field; and
said step of determining whether any secret value deciphers any cipher data field further comprises determining whether any digital signature is reproduced by the particular function of the message data and any secret value in the first set.

3. The method as recited in claim 2, wherein the particular function is a hash function that produces a digital signature of binary digits.

4. The method as recited in claim 1, wherein:
each cipher data field is an encrypted message; and
said step of determining whether any secret value deciphers any cipher data field further comprises determining whether a valid message is deciphered from any cipher data field using any secret value in the first set.

5. The method as recited in claim 1, wherein the domain plurality of network nodes is a plurality of routers.

6. The method as recited in claim 1, wherein the network protocol control message is a link layer tunneling protocol control message.

7. The method as recited in claim 1, further comprising receiving shared secret data for a plurality of network nodes of the domain plurality at a plurality of different times that span a time duration greater than about one hour.

8. The method as recited in claim 1, said step of receiving shared secret data further comprising the steps of:
receiving manual input; and
receiving the shared secret data in response to the manual input.

9. The method as recited in claim 8, said step of receiving shared secret data further comprising receiving the shared secret data based on the manual input:

10. The method as recited in claim 1, said step of receiving shared secret data further comprising receiving shared secret data that indicates adding a particular secret value to the first set of secret values.

11. The method as recited in claim 1, wherein:
the first set includes a plurality of secret values; and
said step of receiving shared secret data further comprising receiving shared secret data that indicates removing a particular secret value from the first set of secret values.

12. A method for exchanging network protocol control messages among network nodes in a trusted domain comprising the steps of:
receiving, at a first network node of a domain plurality of network nodes, shared secret data that indicates a plurality of secret values, wherein each secret value is shared among a plurality of network nodes in the domain plurality;
generating a network protocol control message that includes a corresponding plurality of cipher data fields, wherein each cipher data field is deciphered using a different one secret value of the plurality of secret values; and
sending the network protocol control message to a second network node in the domain plurality.

13. The method as recited in claim 12, wherein the second network node is not in a first plurality of network nodes that shares a first secret value of the plurality of secret values.

14. The method as recited in claim 13, wherein the second network node is in a second plurality of network nodes that shares a different second secret value of the plurality of secret values.

15. The method as recited in claim 12, said step of receiving shared secret data further comprising receiving shared secret data that indicates removing a particular secret value from the plurality of secret values.

16. A method for changing a secret value used to authenticate network protocol control messages among network nodes in a trusted domain comprising the steps of:
configuring each network node in a domain plurality of network nodes to use a first secret value to authenticate network protocol control messages among network nodes in the domain plurality;
after every network node in the domain plurality has been configured with the first secret value, configuring each network node in the domain plurality to use a different second secret value to authenticate network protocol control messages among network nodes in the domain plurality; and
after every network node has been configured with the second secret value, configuring each network node in the domain plurality to no longer use the first secret value to authenticate network protocol control messages, whereby a configured secret value for authentication is changed from the first secret value to the second secret value while maintaining communication of network protocol control messages among the domain plurality of network nodes.

17. The method as recited in claim 16, wherein the network protocol control messages authenticated using the first secret value are transmitted over the same control connection as the network protocol control messages authenticated using the second secret value.

18. The method as recited in claim 16, said steps of configuring each network node in the domain plurality further comprising configuring each network node in the domain plurality according to a first sequence of network nodes that causes fewer interruptions in network service than a different second sequence.

19. The method as recited in claim 16, said steps of configuring each network node in the domain plurality further comprising configuring each network node in the domain plurality in a sequence ordered by local time zone and synchronized with a particular local time.

20. A computer-readable medium carrying one or more sequences of instructions for exchanging network protocol control messages among network nodes in a trusted domain, wherein execution of the one or more sequences of instructions by one or more processors causes the one or more processors to perform the steps of:
receiving, at a particular network node of a domain plurality of network nodes, shared secret data that indicates a first set of one or more secret values, wherein each secret value is shared among a plurality of network nodes in the domain plurality;
receiving, at the particular network node, a network protocol control message that includes a second set of one or more cipher data fields, wherein each cipher data field is deciphered using a secret value shared among a plurality of network nodes in the domain plurality;
determining whether any secret value in the first set deciphers any cipher data field in the second set; and
if it is determined that no secret value in the first set deciphers any cipher data field in the second set, then rejecting the network protocol control message,
wherein at least one of the first set and the second set has a plurality of members, and each different member of the plurality of members in one set involves a different secret value.

21. A computer-readable medium carrying one or more sequences of instructions for exchanging network protocol control messages among network nodes in a trusted domain, wherein execution of the one or more sequences of instructions by one or more processors causes the one or more processors to perform the steps of:
receiving, at a first network node of a domain plurality of network nodes, shared secret data that indicates a plurality of secret values, wherein each secret value is shared among a plurality of network nodes in the domain plurality;
generating a network protocol control message that includes a corresponding plurality of cipher data fields, wherein each cipher data field is deciphered using a different one secret value of the plurality of secret values; and
sending the network protocol control message to a second network node in the domain plurality.

22. A computer-readable medium carrying one or more sequences of instructions for changing a secret value used to authenticate network protocol control messages among network nodes in a trusted domain, wherein execution of the one or more sequences of instructions by one or more processors causes the one or more processors to perform the steps of:
configuring each network node in a domain plurality of network nodes to use a first secret value to authenticate network protocol control messages among network nodes in the domain plurality;
after every network node in the domain plurality has been configured with the first secret value, configuring each network node in the domain plurality to use a different second secret value to authenticate network protocol control messages among network nodes in the domain plurality; and
after every network node has been configured with the second secret value, configuring each network node in the domain plurality to no longer use the first secret value to authenticate network protocol control messages, whereby a configured secret value for authentication is changed from the first secret value to the second secret value while maintaining communication of network protocol control messages among the domain plurality of network nodes.

23. An apparatus for exchanging network protocol control messages among network nodes in a trusted domain, comprising:
means for receiving, at a particular network node of a domain plurality of network nodes, shared secret data that indicates a first set of one or more secret values, wherein each secret value is shared among a plurality of network nodes in the domain plurality;
means for receiving, at the particular network node, a network protocol control message that includes a second set of one or more cipher data fields, wherein each cipher data field is deciphered using a secret value shared among a plurality of network nodes in the domain plurality;
means for determining whether any secret value in the first set deciphers any cipher data field in the second set; and
means for rejecting the network protocol control message if it is determined that no secret value in the first set deciphers any cipher data field in the second set,
wherein at least one of the first set and the second set has a plurality of members, and each different member of the plurality of members in one set involves a different secret value.

24. An apparatus for exchanging network protocol control messages among network nodes in a trusted domain, comprising:
means for receiving, at a first network node of a domain plurality of network nodes, shared secret data that indicates a plurality of secret values, wherein each secret value is shared among a plurality of network nodes in the domain plurality;
means for generating a network protocol control message that includes a corresponding plurality of cipher data fields, wherein each cipher data field is deciphered using a different one secret value of the plurality of secret values; and
means for sending the network protocol control message to a second network node in the domain plurality.

25. An apparatus for changing a secret value used to authenticate network protocol control messages among network nodes in a trusted domain comprising:
means for configuring each network node in a domain plurality of network nodes to use a first secret value to authenticate network protocol control messages among network nodes in the domain plurality;
means for configuring each network node in the domain plurality to use a different second secret value to authenticate network protocol control messages among network nodes in the domain plurality, after every network node in the domain plurality has been configured with the first secret value; and
means for configuring each network node in the domain plurality to no longer use the first secret value to authenticate network protocol control messages, after every network node has been configured with the second secret value, whereby a configured secret value for authentication is changed from the first secret value to the second secret value while maintaining communication of network protocol control messages among the domain plurality of network nodes.

26. An apparatus for exchanging network protocol control messages among network nodes in a trusted domain, comprising:
a network interface that is coupled to a network for communicating one or more packet flows therewith;
one or more processors; and
one or more stored sequences of instructions which, when executed by the one or more processors, causes the one or more processors to carry out the steps of:
receiving, at a particular network node of a domain plurality of network nodes, shared secret data that indicates a first set of one or more secret values, wherein each secret value is shared among a plurality of network nodes in the domain plurality;
receiving, at the particular network node, a network protocol control message that includes a second set of one or more cipher data fields, wherein each cipher data field is deciphered using a secret value shared among a plurality of network nodes in the domain plurality;
determining whether any secret value in the first set deciphers any cipher data field in the second set; and
if it is determined that no secret value in the first set deciphers any cipher data field in the second set, then rejecting the network protocol control message,
wherein at least one of the first set and the second set has a plurality of members, and each different member of the plurality of members in one set involves a different secret value.

27. The apparatus as recited in claim 26, wherein:
the network protocol control message also includes message data different from the second set of one or more cipher data fields;
each cipher data field of the second set is a digital signature produced as a particular function of the message data and a secret value associated with the cipher data field; and
said step of determining whether any secret value deciphers any cipher data field further comprises determining whether any digital signature is reproduced by the particular function of the message data and any secret value in the first set.

28. The apparatus as recited in claim 27, wherein the particular function is a hash function that produces a digital signature of binary digits.

29. The apparatus as recited in claim 26, wherein:
each cipher data field is an encrypted message; and
said step of determining whether any secret value deciphers any cipher data field further comprises determining whether a valid message is deciphered from any cipher data field using any secret value in the first set.

30. The apparatus as recited in claim 26, wherein the domain plurality of network nodes is a plurality of routers.

31. The apparatus as recited in claim 26, wherein the network protocol control message is a link layer tunneling protocol control message.

32. The apparatus as recited in claim 26, wherein execution of the one or more stored sequences of instructions causes the one or more processors to carry out the step of receiving shared secret data for a plurality of network nodes of the domain plurality at a plurality of different times that span a time duration greater than about one hour.

33. The apparatus as recited in claim 26, said step of receiving shared secret data further comprising the steps of:
receiving manual input; and
receiving the shared secret data in response to the manual input.

34. The apparatus as recited in claim 33, said step of receiving shared secret data further comprising receiving the shared secret data based on the manual input:

35. The apparatus as recited in claim 26, said step of receiving shared secret data further comprising receiving shared secret data that indicates adding a particular secret value to the first set of secret values.

36. The apparatus as recited in claim 26, wherein:
the first set includes a plurality of secret values; and
said step of receiving shared secret data further comprising receiving shared secret data that indicates removing a particular secret value from the first set of secret values.

37. An apparatus for exchanging network protocol control messages among network nodes in a trusted domain, comprising:
a network interface that is coupled to a network for communicating one or more packet flows therewith;
one or more processors; and
one or more stored sequences of instructions which, when executed by the one or more processors, causes the one or more processors to carry out the steps of:
receiving, at a first network node of a domain plurality of network nodes, shared secret data that indicates a plurality of secret values, wherein each secret value is shared among a plurality of network nodes in the domain plurality;
generating a network protocol control message that includes a corresponding plurality of cipher data fields, wherein each cipher data field is deciphered using a different one secret value of the plurality of secret values; and
sending the network protocol control message to a second network node in the domain plurality.

38. The apparatus as recited in claim 37, wherein the second network node is not in a first plurality of network nodes that shares a first secret value of the plurality of secret values.

39. The apparatus as recited in claim 38, wherein the second network node is in a second plurality of network nodes that shares a different second secret value of the plurality of secret values.

40. The apparatus as recited in claim 37, said step of receiving shared secret data further comprising receiving shared secret data that indicates removing a particular secret value from the plurality of secret values.

41. A system for changing a secret value used to authenticate network protocol control messages among network nodes in a trusted domain, comprising a domain plurality of network nodes, each network node comprising:
a network interface that is coupled to a network for communicating one or more packet flows therewith;
one or more processors; and
one or more stored sequences of instructions which, when executed by the one or more processors in the domain plurality of network nodes, causes the one or more processors to carry out the steps of:
configuring the network node to use a first secret value to authenticate network protocol control messages among network nodes in the domain plurality;
after every network node in the domain plurality has been configured with the first secret value, configuring the network node to use a different second secret value to authenticate network protocol control messages among network nodes in the domain plurality; and
after every network node has been configured with the second secret value, configuring the network node to no longer use the first secret value to authenticate network protocol control messages,
whereby a configured secret value for authentication is changed from the first secret value to the second secret value while maintaining communication of network protocol control messages among the domain plurality of network nodes.

42. The system as recited in claim 41, wherein the network protocol control messages authenticated using the first secret value are transmitted over the same control connection as the network protocol control messages authenticated using the second secret value.

43. The system as recited in claim 41, said step of configuring the network node further comprising configuring each network node in the domain plurality according to a first sequence of network nodes that causes fewer interruptions in network service than a different second sequence.

44. The system as recited in claim 41, said step of configuring the network node further comprising configuring each network node in the domain plurality in a sequence ordered by local time zone and synchronized with a particular local time.
